(19) United States
(12) Patent Application Publication
(10) Pub. No.: US 2019/0241744 A1
(43) Pub. Date: Aug. 8, 2019

(54) THERMOPLASTIC COMPOSITE

(71) Applicant: SHELL OIL COMPANY, HOUSTON, TX (US)

(72) Inventor: Jean Paul Andre Marie Joseph Ghislain LANGE, Amsterdam (NL)

(21) Appl. No.: 16/341,952

(22) PCT Filed: Oct. 13, 2017
(86) PCT No.: PCT/EP2017/076249

§ 371 Date: Apr. 15, 2019

(30) Foreign Application Priority Data
Oct. 17, 2016 (EP) 16194232.1

(51) Int. Cl. C08L 95/00; C08J 5/04; C08H 8/00

(52) U.S. Cl. CPC C08L 95/00; C08J 5/045; C08J 2497/02; C08L 2205/16; C08J 2395/00; C08H 8/00

(57) ABSTRACT

A reinforced composite material comprises a blend of a thermoplastic matrix and cellulosic fibers, wherein the thermo-plastic matrix comprises a tarry residue fraction from a lignocellulosic biomass liquefaction process. A process for the manufacture of the reinforced composite material comprises subjecting a lignocellulosic biomass to liquefaction in the presence of a liquefaction solvent to form a liquefaction product and a tarry residue; separating the tarry residue from the liquefaction product; and blending the tarry residue with cellulosic fibers to form a recyclable reinforced thermoplastic composite material.

### FIELD OF THE INVENTION

The invention relates to a thermoplastic composite, and more especially to a recyclable thermoplastic composite and a process for manufacture thereof.

### BACKGROUND TO THE INVENTION

In recent years, a significant amount of attention has been placed on developing new technologies for providing energy from resources other than fossil fuels. Biomass is a resource that shows promise as a fossil fuel alternative, and has the advantage of being a renewable fuel source. Wood-based biomass shows particular promise as a fuel source since it is renewable in a relatively short time frame and its use as an energy source is carbon neutral.

Lignocellulosic biomass is readily available and relatively inexpensive, for example, it can be obtained from forestry and agricultural residues, waste and recycled paper, pulp and paper mill residues, etc. Several processes exist for conversion of biomass, including pyrolysis, gasification, liquefaction, hydrolysis, hydrogenolysis and combustion. Liquefaction is a thermochemical process generating liquid bio-crude and co-products, usually conducted under moderate temperatures (e.g. 300-400° C.) and pressures (e.g. 2-20 MPa), optionally using hydrogen or CO as reducing agent. Depending on the processing conditions, liquefaction of biomass can produce fuels for heavy engines, such as for marine and rail use, or when upgraded for transportation fuels, such as diesel, gasoline or jet-fuels. Such cellulosic biomass is most conveniently converted at locations where the biomass is generated.

Liquefaction of lignocellulosic biomass is preferred over pyrolysis, due to resulting lower oxygen content in the bio-crude and a higher oil yield. Products of liquefaction generally include a gas phase portion, a liquid oily fraction, a liquid aqueous fraction and a solid or tarry residue. Conversion of lignocellulosic feedstock may be conveniently performed in a phenolic solvent, such as guaiacol, at temperatures in excess of 250° C., usually at about 300-350° C., without requiring a reactive atmosphere. The conversion is also usually carried out at high pressure, for example, at pressures of 5-20 MPa. The solvent is progressively replaced during the process with the produced oil via a recycling link.

One disadvantage of such a process however is the formation of heavy components (MW>1,000 Da) which increase the viscosity of the bio-crude upon recycling the bio-crude or a fraction thereof as liquefaction solvent. It is believed that lignin itself is the major contributor to the heavy fraction and ultimately the increase in the fraction of heavy components in the recycled liquefaction solvent hinders the liquefaction process. Efforts have therefore been focused on minimizing the production of the undesirable heavy fraction and maximizing the amount of useful liquid bio-crude obtained by the process, for example, by optimizing the process parameters such as temperature, reaction time, water contents, etc.

The liquid bio-crude produced by the liquefaction process is typically separated from added solvent (e.g. guaiacol). Conveniently, the fraction of guaiacol in the liquefaction oil is relatively small as the majority of guaiacol introduced into the process at the outset is already removed by recycling of the liquefaction oil. Initially, the lightest fractions of the liquefaction oil (including water) may be removed through atmospheric distillation, for example, at temperatures up to 130° C. After removal of the light, aqueous fraction, the remaining product of the liquefaction process is vacuum distilled. Vacuum distillation may take place at pressures of <0.5 bar, preferably <0.2 bar, more preferably <0.1 bar, more preferably <0.05 bar and most preferably <0.01 bar and >0.001 bar, preferably >0.005 bar, more preferably >0.01 bar and most preferably >0.05 bar, and at temperatures of >100° C., preferably >150° C., more preferably >200° C. and most preferably >250° C. and <400° C., preferably <350° C. and most preferably <300° C.

Following vacuum distillation, a tarry residue is left, this is often referred to simply as “vacuum residue”. Generally, the tarry residue will solidify upon cooling to ambient temperatures. For simplicity, the term “tarry residue” as used herein embraces solid residue. Despite efforts to minimize the heavy fraction, the amount of tarry residue remaining after separating off the useful liquid bio-crude may be substantial. For example, the weight of tarry residue remaining may amount to about 25-30 wt % of the weight of the biomass introduced into the liquefaction process when the distillation is run at relatively harsh conditions, such as at about 350° C. and 50 mbar, rising to 50 wt % or greater of vacuum residue that is still solid at room temperature under gentler distillation conditions, such as at about 200° C.

It would therefore be advantageous to be able to make use of the tarry residue, especially a use that is environmentally sustainable consistent with it being a by-product in the production of a renewable energy source.

### SUMMARY OF THE INVENTION

Such use has been achieved in the present invention. Accordingly, the invention resides in a reinforced composite material comprising a blend of a thermoplastic matrix and cellulosic fibers, wherein the thermoplastic matrix comprises a tarry residue fraction from a lignocellulosic biomass liquefaction process.

### BRIEF DESCRIPTION OF THE DRAWINGS

FIG. 1 shows a stress-strain diagram of pure vacuum residue compared with vacuum residue blended with natural fibers.

### DETAILED DESCRIPTION OF THE INVENTION

The present inventors have surprisingly found that the tarry residue fraction obtained from liquefaction of a lignocellulosic biomass when blended with cellulosic fibers provides a useful thermoplastic material.

In addition to displaying mechanical properties approaching those of conventional thermoplastic materials, such as polystyrene, polyvinylchloride, low and high density polyethylene, etc. the composite material according to the present invention may be fully recyclable. For example, the composite material may be recycled by processing in a biomass liquefaction process whereupon the reinforcing cellulosic fibers of the composite are converted to form a bio-crude fraction along with tarry residue. This “new” tarry residue, which now includes products derived from the recycled composite material, may then be blended with fresh fibers to form a new recycled composite. In this way, the tarry residue (the residue after vacuum distillation) of the liquefaction process is advantageously used to form a useful material which is fully recyclable.

From another aspect, the invention resides in a process for the manufacture of a reinforced composite material, the process comprising:

subjecting a lignocellulosic biomass to liquefaction in the presence of a liquefaction solvent to form a liquefaction product and a tarry residue;

separating the tarry residue from the liquefaction product; and

blending the tarry residue with cellulosic fibers to form a recyclable reinforced thermoplastic composite material.

Fiber-reinforced materials are generally desirable for their mechanical properties. Due to the often poor interfacial bonding between natural fibers and a polymer matrix, use of compatibilisers has been widespread. However, hitherto, fiber-reinforced composites have not been recycled due to the challenges of separating fibers from the plastic matrix, making recycling commercially unviable. It is known, for example, to be difficult to separate fibers, whether carbon fibers, glass fibers or natural fibers, in relation to both fossil-based composites as well as renewable composites. Moreover, bio-based thermoplastic polymers have generally been obtained only from relatively expensive feedstock and/or using relatively expensive processes. For example, they have been obtained by conversion of sugars to well-defined monomers, and subsequent polymerization; the sugars being derived from expensive starch or sucrose, or extracted at high cost from lignocellulose. Thus by means of the process of the present invention, it is possible easily to produce recyclable thermoplastic materials from a low cost bio-based feed using a simple process, and thereafter to recycle the material in the same, simple and cost-effective manner.

The reinforced composite material of the invention may be used in many applications where conventional thermoplastics are used. For example the composite material of the invention may be molded to form industrial products useful in construction, household items and outdoor accessories. Further, when such products reach the end of their useful lives or are no longer required, the material can be fully recycled simply by introduction into a liquefaction process. In this way, the composite may be processed in the same manner as virgin lignocellulose (e.g. under the same conditions as the first step in the aforementioned process of the invention), and the resulting tarry residue separated from the liquefaction product can be blended with further cellulose fibers to produce a recycled composite material.

In circumstances when the reinforced composite material of the invention has been combined with metal or ceramic components, for example so as to create an industrial item, it is straightforward to separate such components from the liquefied composite during the recycling process. In particular, it is possible to filter any such metal/ceramic components from the liquid whether for disposal or recycling.

The tarry residue obtained from the liquefaction process is typically characterized as having a much lower average molecular weight than a conventional thermoplastic material (e.g. the average molecular weight of the tarry residue can be in the region of 1.8 kDa, whereas a conventional thermoplastic may have an average molecular weight in the region of 100 kDa). Melting temperatures for the residue typically range between 100 and 170° C. Moreover, tensile tests indicate brittle behavior with no discernible plastic deformation observed. It is therefore surprising that useful mechanical properties can be achieved simply by blending the tarry residue with cellulosic fibers.

After blending of the tarry residue and cellulosic fibers to form the composite material of the invention, the blend may be compacted and/or agglomerated to produce granules. Granules may be readily packaged and transported ready for further processing to transform the composite material into the desired end products.

The lignocellulosic biomass for use in the invention may come from virgin biomass, waste biomass or an energy crop. Preferably the biomass is derived from woody feedstocks, including from softwoods and hardwoods, for example beech wood or pine wood, or from non-woody feedstocks, including grasses, for example bagasse, or from other agricultural residues such as coconut husk, corn stalk, and the like. Bagasse is especially preferred. Bagasse is the fibrous matter that remains, for example, after sugarcane or sorghum stalks have been crushed to extract their juice. It is an abundant resource given that for each 10 tonnes of sugarcane crushed, there will be about 3 tonnes of wet bagasse produced. The lignocellulosic biomass may also comprise a composite of liquefaction bio-crude or lignin with cellulosic fibers, the lignin being derived from a pyrolysis process, a pulping process (Kraft or organosols) or from another biomass pretreatment process.

Before being used in the process of the invention, the lignocellulosic material is preferably processed into small particles. Preferably, the lignocellulosic material is processed into particles having a particle size distribution with an average particle size of equal to or more than 0.05 millimeter, more preferably equal to or more than 0.1 millimeter, most preferably equal to or more than 0.5 millimeter and preferably equal to or less than 20 centimeters, more preferably equal to or less than 10 centimeters and most preferably equal to or less than 3 centimeters. For practical purposes the particle size in the centimeter and millimeter range can be determined by sieving.

In one embodiment, the lignocellulosic material may have been dried before use in the process of the invention.

In another embodiment the lignocellulosic material has not been dried or been only partly dried to reach a water content of 5 to 80 wt %, preferably 20 to 50 wt %, based on the total weight of lignocellulosic material and water. Optionally, the lignocellulosic material can be impregnated with water to reach a moisture content of 5 to 80 w %, preferably 20 to 50 w %.

The cellulosic fibers are preferably natural fibers, hence from a biorenewable resource, and may comprise virgin fibers or processed fibers, or a mixture thereof. Such natural fibers may comprise pure cellulose or lignocellulose and may be obtained from a variety of sources. For example, the fibers can be derived from wood, including waste wood, grass, agricultural and forestry residues, or from pulp, including pulp derived from Kraft or organosols pre-treatment, or from acid, base or water pre-treatment.

The fibers may be added in various sizes, but are preferably processed into smaller particle sizes as per the lignocellulosic material as hereinbefore described. More preferably, the fibers are ground or milled into fine particles having a particle size distribution with an average particle length of less than 10 mm, preferably less than 3 mm, more preferably less than 1 mm, more preferably less than 0.3 mm, more preferably less than 0.1 mm, more preferably less than 0.03 mm and most preferably less than 0.01 mm.

The unconverted or processed fibres may be added to the tarry residue in suitable amounts according to the desired properties of the thermoplastic composite. The amount of fibers may also affect the ease of processing the blend when the blend is formed into the chosen end product. For example, the blend may be compression molded to produce the end product. In a compression molding process, the blend may require heating to temperatures in the region of 130 to 250° C., more typically in the region of 160-200° C. The composite materials of the present invention may of course alternatively be transformed to their end products by injection molding or extrusion.

Since the tarry residue is solid under ambient conditions, it is preferably blended with the fibers at elevated temperature, more preferably above the melting point of the tar, in order that the fibers may be more evenly dispersed. Advantageously, the tarry residue is blended with the fibers at the liquefaction site, as opposed to transferring the vacuum residue to a separate processing plant, in keeping with the environmental credentials of the resulting thermoplastic product.

Preferably, the fibers are added to the tarry residue in an amount greater than 1 wt %, more preferably greater than 3 wt %, more preferably greater than 10 wt %, more preferably greater than 20 wt % and most preferably greater than 50 wt %, and preferably in an amount less than 80 wt %, more preferably less than 60 wt % and most preferably less than 50 wt %. Weight percentages are expressed as dry weight.

While bagasse may be used wet (following crushing of the sugarcane, the bagasse tends to have a high moisture content, typically 40-50 wt %), it is preferably allowed to dry to a moisture content of less than 20 wt %, more preferably less than 10 wt %, more preferably less than 5 wt % and most preferably less than 2 wt % before use in the present process. The blending process typically takes place above the melting/softening point of the tarry residue, hence residual moisture in the fibers will in any event be driven off during the process.

The lignocellulosic biomass from which the tarry residue is derived may be the same as or different from the cellulosic feedstock that provides the fibers for reinforcing the composite. Of course, upon recycling of the thermoplastic composite, the tarry residue thereafter will be derived from both cellulosic sources, if they are different.

In the process of the invention, the liquefaction step is generally carried out in the presence of a solvent, particularly a liquid solvent.

By a liquid solvent is herein preferably understood a solvent that is liquid at a pressure of 0.1 MPa (1 bar absolute) and a temperature of 80° C. or higher, more preferably 100° C. or higher. Most preferably a liquid solvent is herein understood to be a solvent that is liquid at the reaction temperature and reaction pressure at which the liquefaction step is carried out.

Hence, the liquid solvent is preferably a solvent which is liquid at a temperature in the range from equal to or more than 260° C. to equal to or less than 400° C. at a pressure of 0.1 MPa. Preferably such liquid solvent is still liquid at a temperature in the range from equal to or more than 260° C. to equal to or less than 400° C. at a higher pressure, for example the pressure during the reaction as mentioned above, for example a pressure of 4 MPa.

When the liquefaction step of the inventive process is first commenced, a solvent is introduced, and this is preferably an oxygenated solvent, more preferably an oxygenated phenolic solvent. Oxygenated solvents are preferred as they may enhance the liquid yield and lower the solid yield as compared to use of water as solvent.

In a preferred embodiment the liquid solvent in the liquefaction step comprises one or more methoxyphenols. Most preferably the liquid solvent comprises at least 1 wt % methoxy-phenols, more preferably at least 10 wt % methoxy-phenols, even more preferably at least 20 wt % methoxy-phenols, based on the total weight of the liquid solvent. Guaiacol (2-methoxyphenol) is especially preferred as this was found to produce a high liquid yield (>90 C %) and a low solid yield (1-2 C %).

As explained herein, the reaction product of the liquefaction step, or a fraction thereof, may act as a liquefaction solvent. Thus in the process of the invention, at least part of the solvent consists of a product mixture obtained from the liquefaction step, preferably a middle fraction thereof. During liquefaction, the light fraction (composed mainly of water and other light product, typically boiling below 100-150° C.) may be at least partly removed to avoid excessive product build up, and the heavy fraction (the tarry residue) may also be partly removed for blending with the cellulose fibers.

The solvent preferably comprises equal to or more than 10 wt %, more preferably equal to or more than 20 wt %, even more preferably equal to or more than 30 wt %, still more preferably equal to or more than 50 wt %, most preferably equal to or more than 80 wt % and preferably equal to or less than 100 wt %, possibly equal to or less 90 wt % (based on the total weight of solvent in the liquefaction step) of such recycled product mixture middle fraction.

In another embodiment, the liquefaction solvent comprises lignin that is operated above its melting point.

In yet another embodiment, the liquefaction solvent comprises the melted matrix of a composite made of liquefaction bio-crude (vacuum residue) or lignin with cellulose fibers. In other words, the reinforced composite material of the invention (i.e. derived from liquefaction tarry residue) or a composite material simply made of lignin and cellulosic fibers may be used in the process of the invention as liquefaction solvent.

In the liquefaction step, optimal processing temperatures may be determined and this may vary according to the lignocellulosic feedstock used. For example, when the feedstock is pine wood, optimal liquefaction temperature is in the range of 300-350° C., enabling an oil yield of about 90% to be achieved.

In another embodiment, the liquid solvent may comprise at least one part consisting of 3rd or higher generation reaction products. By a x-th generation reaction product is herein understood a reaction product that has been obtained by recycling and reacting the original reaction product from the liquefaction step for x-times. For example a 3rd generation or higher generation reaction product may have been obtained by re-reacting recycled preceding (e.g. 2nd or lower) generation reaction products in the liquefaction step. For example, in the liquefaction step, the lignocellulosic material may be converted into a product mixture comprising a 1st generation reaction product; where after the separation step, a middle fraction comprising the 1st generation reaction product may be separated. The selected product mixture middle fraction comprising the 1st generation reaction product may be recycled to the liquefaction step, where the 1st generation reaction product may be converted (re-reacted) to a 2nd generation reaction product. The product mixture may be again separated in the separation step and a middle fraction comprising the 2nd generation reaction product may be selected. The selected product mixture middle fraction comprising the 2nd generation reaction product may be recycled to the liquefaction step, where the 2nd generation reaction product may be converted (re-reacted) to a 3th generation reaction product, etc.

In a preferred embodiment the liquid solvent comprises at least 10 wt %, more preferably at least 30 wt % and most preferably at least 50 wt % (based on the total weight of liquid solvent) of 3th or higher generation reaction products. More preferably the liquid solvent comprises at least 10 wt %, more preferably at least 30 wt % and most preferably at least 50 wt % (based on the total weight of liquid solvent) of 4th or higher generation reaction products. Most preferably the liquid solvent comprises at least 10 wt %, more preferably at least 30 wt % and most preferably at least 50 wt % (based on the total weight of liquid solvent) of 5th or higher generation reaction products.

The weight ratio of recycled product mixture middle fraction to lignocellulosic material (PMMF:LCM) in the liquefaction step preferably lies in the range from 1:1 to 100:1, more preferably in the range from 2:1 to 50:1, most preferably in the range from 5:1 to 20:1.

The composition of the recycled product mixture middle fraction is described in more detail below.

It will be appreciated that during the course of the liquefaction process, the composition of the liquefaction solvent will gradually change, with the content of recycled product liquefaction solvent increasing and the solvent derived from a source other than the lignocellulosic material decreasing as recycling continues.

Water may be used as a co-solvent in the liquefaction process and this may assist to decrease the amount of tarry residue produced. The water in the liquid solvent may for example be generated in-situ during the conversion.

The solvent in the liquefaction step may comprise water in an amount of less than or equal to 30 wt %, more preferably an amount of less than or equal to 25 wt %, and most preferably less than or equal to 20 wt %, based on the total weight of solvent. Reducing the amount of water further by running the process relatively dry may be advantageous when it is desired to maximize the production of tarry residue.

The liquefaction process may be carried out batch-wise, semi batch-wise (e.g. through regular addition of fresh biomass into the liquefaction product) or continuously (e.g. through continuous feeding of fresh biomass together with fresh and recycled solvent).

The present invention will now be illustrated in the following Examples.

### EXAMPLE 1

### Liquefaction of Pine Wood in Guaiacol

2.2 kg of guaiacol was introduced into a 5 L autoclave together with pine wood that had been crushed to an average particle size of about 0.5 mm and dried at 105° C. for 24 hours in a ratio of guaiacol to pine wood of 7.5:1. The mixture was heated to 300° C. over a period of 2-3 hours, and maintained at a temperature between 300-310° C. for a further 2-3 hours. After, the reactor was cooled to room temperature and the gas was released. The same amount of fresh biomass was introduced in a series of refills and a portion of the oil was removed. The portion of oil removed equated to the expected oil yield thereby preventing mass accumulation in the reactor and maintaining a solvent:pine wood ratio of 7.5:1. The amount of heavies (>1,000 Da) gradually increased by refilling the reactor with fresh biomass and recycling the produced bio-crude. Refilling the reactor with fresh biomass led to an increase in viscosity. After 6 refills the run was terminated because the oil became a paste-like substance. 2.1 kg of bio-crude was obtained, this portion including the remaining guaiacol. The formed bio-crude was recovered by distilling the liquefaction product at 135° C. (bottom temperature) and 1 bar to remove the light fraction and subsequently at 120° C. (bottom temperature) under a vacuum of 4 mbar to remove the solvent fraction leaving 550 g of solid vacuum residue. This solid vacuum residue was then used as the basis for a thermoplastic composite.

### EXAMPLE 2

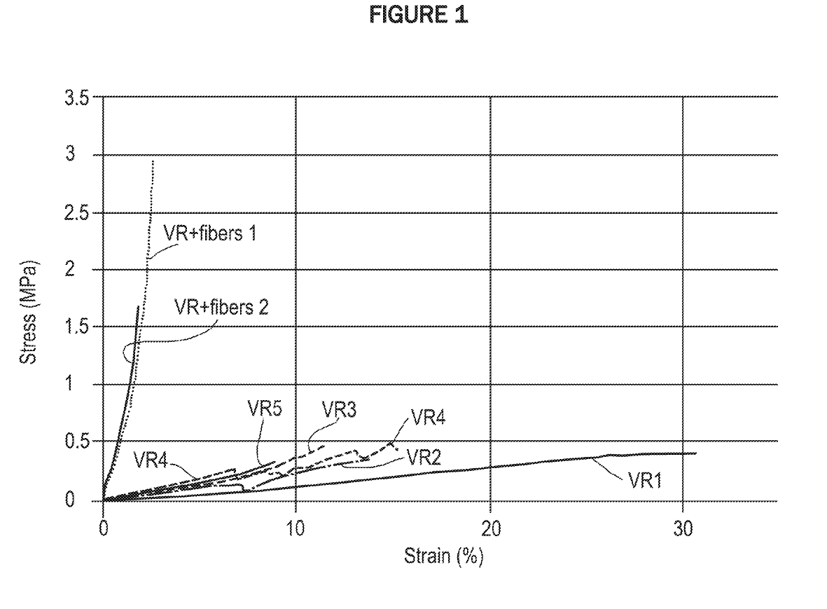

Vacuum residue obtained from Example 1 was blended with 10 wt % natural fibres (bagasse). The fibre-reinforced vacuum residue showed an increased viscosity while heating to a compression molding temperature of about 170° C. Molding of the resulting reinforced material was easier than molding of the vacuum residue alone, and the stress-strain properties of the reinforced material (VR+fibers 1 and VR+fibers 2) as compared with pure vacuum residue (VR1 to VR5)is shown in FIG. 1.

It will be understood that the fibre-reinforced composite material displayed much improved tensile strength over pure vacuum residue, increasing from 0.4 MPa to 2.3 MPa. The modulus of elasticity of the fibre-reinforced residue displayed a 20-fold increase over the pure vacuum residue.

As well as having properties suitable for the production of molded thermoplastic articles for a variety of uses, the fibre-reinforced composite material of the invention is fully recyclable. The benefits in blending natural fibres with the normally undesired heavy fraction from a biomass conversion are unexpected and surprising.

1. A reinforced composite material comprising a blend of a thermoplastic matrix and cellulosic fibers, wherein the thermoplastic matrix comprises a tarry residue fraction from a lignocellulosic biomass liquefaction process.

2. The composite material according to claim 1, wherein the thermoplastic matrix is derived from liquefaction of one or more of a woody feedstock, a grassy feedstock, and recycled reinforced composite material.

3. The composite material according to claim 1, wherein the thermoplastic matrix is derived from one or more of beech wood, pine wood, bagasse, coconut husk and corn stalk.

4. The composite material according to claim 1, wherein the cellulosic fibres are blended with the thermoplastic matrix in an amount greater than 1 wt %, more preferably greater than 3 wt %, more preferably greater than 10 wt %, more preferably greater than 20 wt % and most preferably greater than 50 wt %, and preferably in an amount less than 80 wt %, more preferably less than 60 wt % and most preferably less than 50 wt %.

5. The composite material according to claim 1 wherein the cellulosic fibres comprise virgin or processed natural fibres.

6. A process for the manufacture of a reinforced composite material, the process comprising:
subjecting a lignocellulosic biomass to liquefaction in the presence of a liquefaction solvent to form a liquefaction product and a tarry residue;
separating the tarry residue from the liquefaction product; and
blending the tarry residue with cellulosic fibers to form a recyclable reinforced thermoplastic composite material.

7. The process of claim 6, wherein the liquefaction is performed in the presence of lignin or a fraction thereof as the liquefaction solvent.

8. The process of claim 6, wherein the liquefaction is performed in the presence of bio-crude or a fraction thereof as the liquefaction solvent.

9. The process of any of claims 6, wherein the liquefaction is performed in the presence of a melted recycled composite material derived from a blend of lignocellulosic biomass and cellulosic fibers as liquefaction solvent.

10. The process of claim 9, wherein the liquefaction is performed in the presence of a recycled reinforced composite material according to claim 1 as the liquefaction solvent.
